(19) United States
(12) Patent Application Publication
(10) Pub. No.: US 2009/0089275 A1
(43) Pub. Date: Apr. 2, 2009

(54) USING USER PROVIDED STRUCTURE FEEDBACK ON SEARCH RESULTS TO PROVIDE MORE RELEVANT SEARCH RESULTS

(75) Inventors: TAL DRORY, HAIFA (IL); DAVID KONOPNICKI, HAIFA (IL)

Correspondence Address: Patents On Demand, P.A.-IBM SVL, 4581 Weston Road, Suite 345, Weston, FL, 33331, US

(73) Assignee: INTERNATIONAL BUSINESS MACHINES CORPORATION, ARMONK, NY (US)

(21) Appl. No.: 11/865,947

(22) Filed: Oct. 2, 2007

(51) Int. Cl. G06F 17/30

(52) U.S. Cl. 707/5; 707/E17.064

(57) ABSTRACT

The present invention discloses a solution of using user provided structure feedback to index electronic documents. In the solution, a search engine can serve search results based on an indexed store of electronic documents to at least user. Structure feedback can be received concerning the search results. The structure feedback can identify at least one structure element of an electronic document and at least one user specified semantic tag for the structure element. The indexed store can be changed to incorporate the structure feedback. The changed index store can be used when subsequently serving search results. The search engine can be a Web search engine and/or a desktop search engine.

### BACKGROUND

1. Field of the Invention

The present invention relates to electronic document searching technologies, and more particularly, to using structure feedback on search results to provide more relevant search results

2. Description of the Related Art

The World Wide Web has become one of the largest sources of information available. The key accessing this information is having the right tools available to search the available information. Most current search tools use Web crawlers in index Web content, where the indexed content is used by search engines. In this process, the content of the document is extracted and, together with a few metadata fields (e.g., title, date, etc.) usually presented in the document header, is indexed.

Currently, indexing allows for faster performance in searching, but is not always sufficient to ensure that query results are relevant. This is why many additional features are implemented by search engines to attempt to increase result relevancy. Presently, these search engines fail to effectively utilize identifiable structures contained within indexed documents. That is, electronic documents often include identifiable structure, which is currently overlooked or are underused by Web crawlers and other indexing engines. Such identifiable structures can include the structure of Extensible Markup Language (XML) files, comma separated value (CSV) files, intra-document metadata, and the like.

To take advantage of the structure, semantics must be associated with a set of defined metadata fields (e.g., Dublin Core fields, Author, Title, etc.). Semantic associations may be unavailable or insufficiently strong to permit mappings at index time. Thus, the electronic documents are conventionally indexed as text only, without structure. One possible reason that semantically relevant metadata has not been advantageously used by searching engines is that automated processes have difficulty accurately handling semantically relevant structures contained within electronic documents. Those structures can vary significantly between different document formats, such as those associated with different document type definition (DTD) files used by different document repositories. Thus, Web crawlers and other such tools are presently unable to perform structure based indexing, which results in a significant repository of content for discerning electronic document meaning being ignored by conventional search techniques.

### SUMMARY OF THE INVENTION

The present invention discloses a solution that allows users to give structure feedback concerning search results. That is, users can identify within an interface a part of an electronic document (returned from a search) and assign semantics to this document part. The user defined semantics can be conveyed to a feedback processor, which uses it to index a set of electronic documents. The new indexing can be used by a search engine when producing future search results. In one embodiment, user's can specifically conduct searches that search for user specified intra-document structures having a user specified value. The search engine can be a Web search engine and/or a desktop search engine.

Repeated use of the disclosed solution can result in a feedback established learning loop, where users train the search engine to improve its performance over time using the user provided structure feedback. The larger the user population that provides feedback, the more accurate the structural information becomes. Thus, over time, highly accurate structural information can be used when indexing a set of searchable documents, such as when using Web crawling techniques to search the Web. Additionally, as different semantics evolve, such as new XML structure conventions, the solution automatically adjusts to incorporate these new structures. Accordingly, structure-semantic mappings established by the disclosed solution can self-update to properly handle constantly changing development conventions.

The present invention can be implemented in accordance with numerous aspects consistent with the material presented herein. For example, one aspect of the present invention can include a method of using user provided structure feedback to index Web documents. In the method, a search engine can serve search results based on an indexed store of electronic documents to at least one user. Structure feedback can be received concerning the search results. The structure feedback can identify at least one structure element of an electronic document and at least one user specified semantic tag for the structure element. The indexed store can be changed to incorporate the structure feedback. The changed index store can be used when subsequently serving search results.

Another aspect of the present invention can include a system for searching electronic documents indexed with user provided structure feedback that includes an index data store and a search engine. The index data store can index a set of electronic documents so that the set is able to be searched using user provided key word input. The search engine can accept the user provided key word input entered via an interface. The search engine can also use the index data store to discover a set of electronic documents most closely matching the user provided key word input. The search engine can then present results of the set of discovered Web documents via the interface. The index data store can include structure based indexes that are created from user provided structure feedback.

Still another aspect of the present invention can include a search engine feedback interface that includes a structure feedback element. The structure feedback element can permit a user to provide structure feedback concerning Web pages or other electronic documents resulting from user searches conducted with a search engine. User provided structure feedback can relate to metadata of the Web pages or other electronic documents. Further, the user provided structure feedback can include user specified semantic tags. The search engine can establish indexes for the Web pages and/or the electronic documents so that the metadata structures are associated with the user specified semantic tags. The established indexes based upon the user provided structure feedback can be used by the search engine when generating search results to be delivered to users.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system that uses structure feedback to improve document search results in accordance with an embodiment of the inventive arrangements disclosed herein.

FIG. 2 is a schematic diagram of a system for using structure feedback in search results to perform structured indexing for more relevant search results in accordance with an embodiment of the inventive arrangements disclosed herein.

FIG. 3 shows an application interface for using structure feedback in search results to perform structured indexing based upon user feedback in accordance with an embodiment of the invention arrangements disclosed herein.

FIG. 4 is flow chart of a method for using structure feedback in accordance with an embodiment of the inventive arrangements disclosed herein.

### DETAILED DESCRIPTION OF THE INVENTION

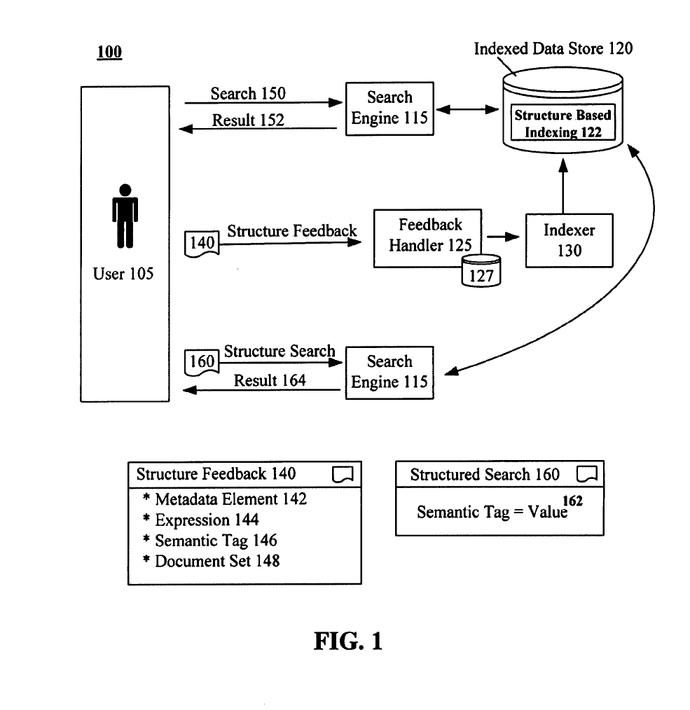

FIG. 1 is a schematic diagram of a system 100 that uses structure feedback to improve document search results in accordance with an embodiment of the inventive arrangements disclosed herein. In system 100, a user 105 can submit a search request 150 to a search engine 115, which uses an index store 120 to produce results 152. The user 105 can provide structure feedback 140 about the results 152, which is sent to a feedback handler 125. The feedback handler 125 can receive feedback 140 from one or more users 105, which is stored in a feedback store 127 and (optionally) processed in batch.

An indexer 130 can re-index the index store 120 and/or add new structure based indexing 122 rules to the store 120 based upon the feedback in feedback store 127. The new indexing can be used when generating future search results. Additionally, users 105 can submit structure specific 160 search criteria to the search engine 115, which is compared against structure index entries 122 to produce results 164.

In a different embodiment, individual feedback 140 messages can be processed immediately as opposed to being handled by batch processes. For example, when an index store 120 is specific to a dedicated document repository (i.e., a hard-drive contained repository of documents on a user's computer) a user 105 can reasonably expect almost immediate indexing, so that new feedback enhanced searches (e.g., 160) can be conducted soon after providing the feedback 140.

Batch processing can be advantageous to minimize user 105 induced errors, when feedback 140 pertains to a user agnostic set of electronic documents, such as all electronic documents forming the World Wide Web. Additionally, safeguards can be established in system 100 to prevent a small set of users 105 from intentionally biasing search engine 115 results by abusing feedback 140 based indexing. A current term for intentionally biasing search engine 115 results to favor a Web site over competing sites is referred to as optimizing a Web site. Numerous techniques are currently being used to ensure optimization efforts do not unreasonably degrade search result accuracy, which can be applied to structure feedback 140 indexing.

The structure feedback 140 can take many forms, one of which includes user 105 input specifying a metadata element 142 and/or a repeating expression 144 together with a semantic tag 146 and a document set 148. The metadata element 142 can be any element of an electronic document designed to be presented or not. For example, structural documents, such as Extensible Markup Language (XML) documents, can be associated with a set of Document Type Definition (DTD) files that define a structure of the XML documents. Structural elements, such as those definable by DTD files are to be considered metadata elements 142.

An expression 144 can be any expression that defines a repeating structural pattern appearing within an electronic document, which includes the metadata element 142. In other words, the expression 144 programmatic defines a structure for indexing the metadata element 140. For example, an XML structure of <location> . . . </location> can be found in electronic documents, where location specific information is contained between the XML tags (142) for location. In the example, the expression 144 can be an XPATH expression or a regular expression.

A semantic tag 146 can be a user provided meaning for a metadata element 142. For example, the location structure can be associated with a semantic tag 146 of Location, City, Place, and the like depending upon what a user 105 specifies. A single metadata element 142 can be associated with multiple different semantic tags 146. A document set 148 can be used to restrict a set of documents to which the structure feedback 140 applies. For example, the document set 148 can specify a document type (e.g., XML documents that comply to some given DTD), can specify a document source (e.g., all Web documents from www.ibm.com/*), and the like. It should be emphasized, that once a semantic tag 146 has been established, users 105 can subsequently use this semantic tag 146 to conduct subsequent searches, as shown by structured search 160. For example, once a semantic tag 146 of “location” has been defined and indexing has been performed, a user 105 can search (150) for “location: London” and receive a set of documents having a structure corresponding to the location semantic tag 146, where the structure includes value of “London”.

In one contemplated embodiment, the indexer 130 can crawl a set of XML files, such as Web files. A-priori, nothing can be known about the semantics of the XML files. While users 105 are searching 150 the XML files, an interface can be available for providing structured feedback 140. The feedback handler 125 can process the feedback 140, which results in new indexes being established by the indexer 130 or existing indexes being modified. The new or modified indexes (122) can be incorporated into Web crawling software agents, which add the feedback specific structural indexing to the XML files. As more users 105 provide consistent feedback 140, feedback specific indexes can be reinforced and more heavily weighted by the search engine 115. When inconsistent feedback 140 is provided an effect of user provided feedback 140 on the search engine 115 can be minimized. Thus, a user 105 established feedback loop can be formed, where the search engine 115 is increasingly trained to yield better results 152 over time.

In one implementation, an interface for performing a structure search 160 can be added to the search engine 115, which permits a structure search 160 to be conveyed to the search engine 115. The search message 160 can specify a value 162 for a semantic tag. The search engine 115 can check the data store 120 for structure elements matching the semantic tag and can determine if any values from Web documents indexed in a structure based indexing 122 portion of store 120 match the value 162 of the structure search message 160. Matches can be returned in as a result 164.

System 100 can define structure for structure feedback 140 purposes in any of a variety of manners. One manner is to highlight a string in an unstructured document. For example, a highlighted string can be a string location: London. The user can edit this string to build a regular expression (144), such as location: (.*). The parentheses can indicate that, in a document that matches the regular expression, the part between parentheses must be saved as the value, as is done in PERL. The regular expression can then be substituted to the search engine 115 together with a semantic tag 146 that is to be associated with the expression. A user 105 can optionally define a set of documents 148 for which the regular expression is relevant. The document set 148 can be an entire corpus or a subset of a document corpus for which the regular expression is relevant. The indexer 130 can then process all the relevant documents in the corpus and add appropriate entries to the structure based indexing 122.

A different manner to define a structure in system 100 is to highlight within a Web page presented in a browser a structure in an XML document, for example the element </location> . . . </location>. The highlighted or otherwise selected structure can be automatically translated into an XPATH expression (e.g., XPATH expression XF can be associated with a particular semantic tag 146). The indexer 130 can index a document corpus based upon the XPATH expression, which results in new entries added to the indexing 122 section of data store 120. After indexing, the search engine 115 can use the new indexes. For example, searching for location:Haita can return all XML documents having a DTD that satisfies an XPATH query XF=Haifa.

Yet another way to define a structure in system 100 is to permit a user to textually enter an expression, which conforms to a set of established rules. The formula entered can be a regular expression in one embodiment, an XPATH expression in a different embodiment, etc. Any definable expression standard can be used so long as it is able to be programmatically interpreted so that a set of Web documents containing metadata elements 142 can be searched and indexed based upon the expression 144.

To elaborate on one contemplated standard, it was previously mentioned that highlighted sections of a Web page can be translated into an XPATH expression. For example, a user can highlight an XML element C in document D. A highlighting software component can require that highlighted portions of an XML document be associated with a complete structural element. Attempts to highlight Web page content other than those programmatically discernable as structural elements can cause an error to be generated. The highlighted element C can be one element of a set of elements C1, . . . , CN of the Web page, where C is considered the metadata element. The user 105 can add expression elements to the metadata element to create a complete XPATH expression. For example, specifying //C can be imbued to mean any occurrence of C in a document. /C1/ . . . /Cn/ can mean any occurrence of C in exactly the same element hierarchy as that in the original occurrence. Subsets can be established, for example, //Ct//C to mean all occurrences of C under Ct(t in [1,N]). The above conventions are just representative of one possible convention for specifying expressions for structure feedback and the invention is not to be construed as limited in this regard.

In system 100, multiple feedback 140 messages can be provided by different users 105 for the same document type and even for the same metadata element. When these feedbacks 140 do not overlap (i.e., no item in the document is associated with more than one feedback message 140), there is no collision. When a potential collision exists between two different messages 140 (e.g., the items use different semantic tags 146 for a common element 142), then the search engine 115 still does not have problems resolving the potential collision since the semantic tag 146 is provided as part of the structure search 160.

For example, two different structure feedback messages 140 can relate to a location (e.g., <location> . . . </location>) metadata element 142; one message can be associated with semantic tag 146 location and another with tag city. In one embodiment, both of these semantic tags 146 can be associated with the same indexing 122 structures so that a search for location:Haifa and city:Haifa will return the same results. In one configuration, synonym mapping can be established for different semantic tags 146, even when mapped synonyms are not associated with user provided feedback 140. In another embodiment, different associations (122) can be established for the different semantic tags 146. When different associations are established, future feedback 140 effecting one of the associations (122) can be independent of the other. For instance, if consistent feedback 140 is provided for the location semantic tag 146, the indexing associations 122 can be increasingly weighted, while if inconsistent feedback 140 is provided for the city semantic tag 146 the indexing associations 122 can be decreasingly weighed.

In one embodiment, different ranking formulas can be applied to structure based indexing 122 depending on received feedback 140. To illustrate, assume that a user 105 searches (160) for Field F with some Value V. In the scenario, Field F has been associated with several XPATH expressions 144. In order to rank the different documents returned by the search 160 message, we need a ranking formula based on a term frequency of different terms that appear in the query. A ranking formula used can be based on a term frequency for the different terms that appear in the query. This default ranking can be modified to take into account an identity and a number of people that have provided feedback 140. That is, a ranking formula can be boosted or weighed to favor a term that corresponds to Field F.

In one implementation, for instance, a multiplicative factor that is proportional to a number of users 105 that have agreed on an expression 144 can be used. For example, a document D can be in a result set since it includes a proper value (e.g., Value V) for Field F. This can be defined using a formula Y on which five users have agreed through feedback 140. Thus Formula Y can be associated with a boost factor or weight of five. A different Formula Z can be agreed upon by only one user, which results in that formula having a boost factor or weight of one. Maximum weights or boost factors can be established. Further, additional significance (resulting in an enhanced boost factor) can exist when a querying user 105 is one of the users associated with a particular formula, such as Formula Y. Ranking algorithms can be established at an arbitrary complexity level so long as the factors needed for programmatically defining a ranking system can be software encoded.

The data stores 120 and 127 shown in system 100 can be physically implemented within any type of hardware including, but not limited to, a magnetic disk, an optical disk, a semiconductor memory, a digitally encoded plastic memory, a holographic memory, or any other recording medium. Data stores 120 and 127 can be a stand-alone storage unit as well as a storage unit formed from a plurality of physical devices which may be remotely located from one another. Additionally, information can be stored within each of the data stores 120 and 127 in a variety of manners. For example, information, such as indexing information 122, can be stored within a database structure or can be stored within one or more files of a file storage system where each file may or may not be indexed for information searching purposes. Information stored in data stores 120 and 127 can be optionally encrypted for added security.

The search engine 115 of system 100 can be a Web search engine and/or a local search engine that indexes electronic documents for a set of one or more local computers. A Web search engine (115) can include engines, such as a GOOGLE engine, a YAHOO engine, and an EXCITE engine. A local search engine (115) can include a desktop search engine, such as GOOGLE desktop search, COPERNIC desktop search, YAHOO desktop search, and the like. Desktop search engines can optionally include an integrated Web searching capability. A local search engine (115) can also be implemented as a hardware-based search appliance, such as a GOOGLE search appliance, a THUNDERSTONE search appliance, and the like.

In an embodiment, one or more DTD files can be used to define structure for documents indexed in data store 120. The indexing by indexer 130 can apply to all documents 148 for which a DTD file is applicable. For example, a single set of DTD files defining structural elements can apply to all indexed XML documents. The disclosed inventive arrangements are not restricted to using DTD files and any structure defining mechanism can be used in system 100 (e.g., XML Schemas).

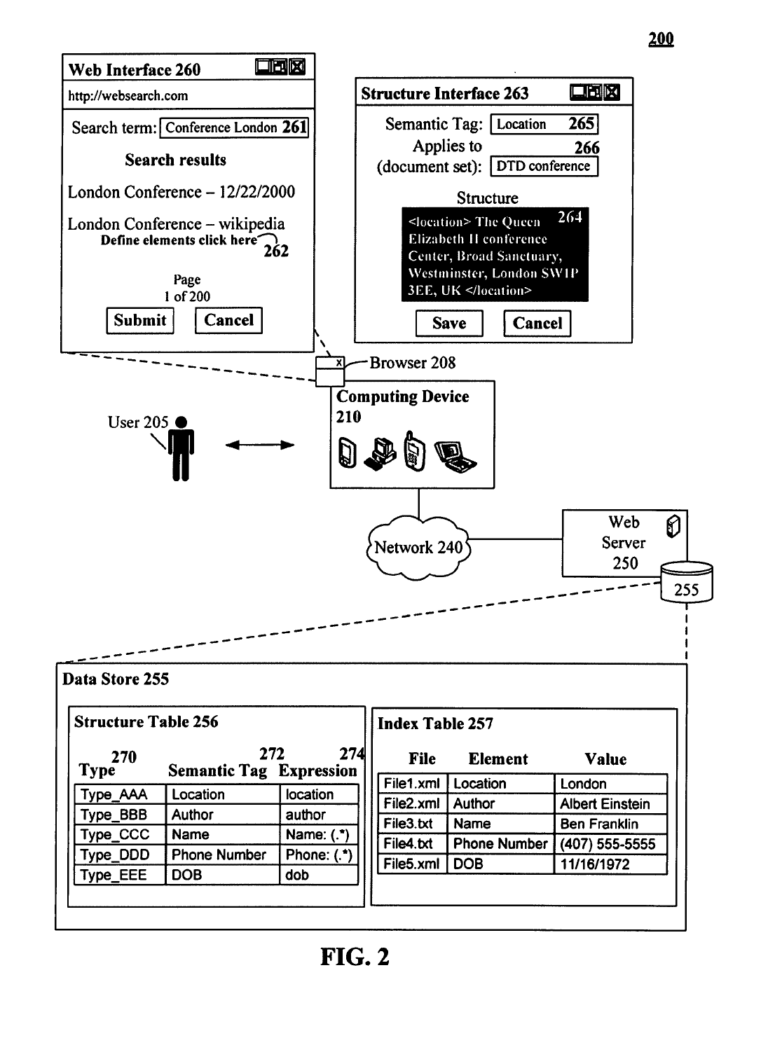

FIG. 2 is a schematic diagram of a system 200 for using structure feedback in search results to perform structured indexing for more relevant search results in accordance with an embodiment of the inventive arrangements disclosed herein. System 200 can represent an implementation of system 100 specific for Web based searches. The invention is not limited in this regard, and in other contemplated embodiments structure feedback can be used to enhance a desktop search engine or a search appliance.

In system 200, user 205 can use Web interface 260 on computing device 210 to interact with Web server 250 and to specifically search for Web content. The Web server 250 can allow user 205 to define distinguishable elements in structured documents. For example, the user 205 can use a GUI option such as Define elements click here 262 of interface 260 to initiate structure interface 263. The user 205 can define distinguishable structure elements within interface 263. After structure elements are defined, Web server 250 can store information regarding the distinguishable elements on data store 255, as shown by tables 256, 257. Tables 256, 257 can include a structure table 256 and an index table 257. Index table 257 and structure table 256 can allow Web server 250 to return more relevant search results to user 205 based upon structure feedback provided by users.

To illustrate, a user 205 can search for terms “conference London” and be presented with a set of Web pages (interface 260) that a search engine believes match the terms. One of these Web pages can be an XML document describing a conference held in London. A user can click on item 262, which causes interface 263 to appear. In interface 263, location element 264 can be specified as <location> The Queen Elizabeth II conference Center, Broad Sanctuary, Westminster, London SWIP 3EE, UK </location>. The user 205 can identify the information associated with the <location> structure by selecting the associated content (e.g., highlighting with a mouse to select as relevant to their search criteria) in some characteristic manner. The user 205 can then associate this highlighted content semantically with the search criteria user specified term 265 in a semantic tag input field or with another element based on user feedback, such as a search term 261.

The highlighted structure 264 can be converted into an expression 274 and associated with the semantic tag 272 and a document type 270 in a structure store table 256. Table 256 can include any and all attributes necessary to index Web documents based on user 205 specified structure. As such, table 256 can include additional attributes that are not explicitly shown in system 200. The items of store 256 can be processed by the Web server 250 and used to index a set of Web documents. The indexing can produce index store table 257. For example, File1.xml can include the location element defined by a user using interfaces 260, 263. A value associated with the location element in File1.xml can be London. Multiple values can be associated with a single element in table 257, and multiple files can be indexed for a structure specified in table 256. The structure feedback process can be dynamic, which causes values of tables 256, 257 to change over time. The information conveyed in Table 257 can be encoded in different data structures for example, using Posting Lists, as done for other metadata, in different search engines.

In system 200, computing device 210 can be any device capable of allowing user 205 to interact with Web interface 260 through network 240. Computing device 210 can be any computing device such as a mobile telephony device such as a cell phone, a personal computer, a server computer, a thin client, a personal data assistant (PDA), or the like. Web interface 260 can be displayed by a Web browser 208. For example, Web interface 260 can display pages server by Web server 250.

The network 240 can include components capable of conveying digital content encoded within carrier waves. The content can be contained within analog or digital signals and conveyed through data or voice channels and can be conveyed over a personal area network (PAN) or a wide area network (WAN). The network 240 can include local components and data pathways necessary for communications to be exchanged among computing device components and between integrated device components and peripheral devices. The network 240 can also include network equipment, such as routers, data lines, hubs, and intermediary servers which together form a packet-based network, such as the Internet or an intranet. The network 240 can further include circuit-based communication components and mobile communication components, such as telephony switches, modems, cellular communication towers, and the like. The network 240 can include line based and/or wireless communication pathways.

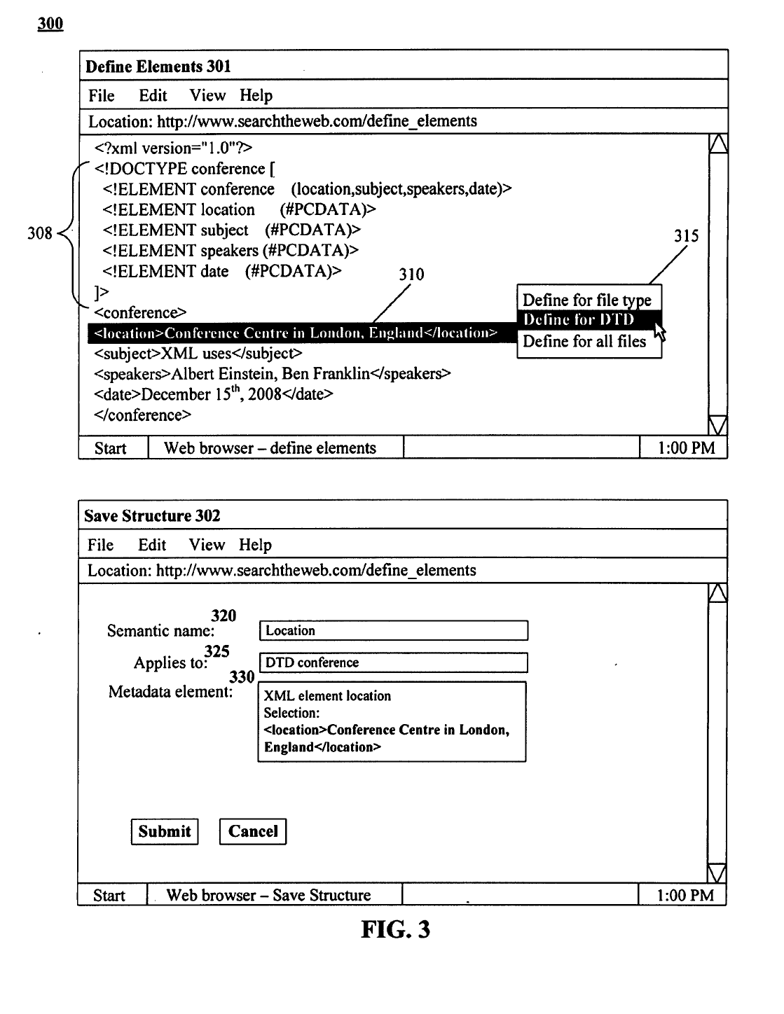

FIG. 3 shows an application interface 300 for using structure feedback in search results to perform structured indexing based upon user feedback in accordance with an embodiment of the invention arrangements disclosed herein. The interface 300 can be an interface used in the context of system 100 or system 200.

Interface 301 can be used to define a set of metadata elements 308 present within an electronic document. Interface 301 shows a markup version of a document. The interface 301 permits a user to highlight a structure 310. After highlighting a structure 310, a popup 315 can be presented. A user can define feedback parameters directly from the popup 315, such as defining a set of documents to which user defined structure feedback is to apply.

Interface 302 can be used to input values through which a user is able to provide structure feedback for electronic documents. The interface 302 can include elements for defining a semantic tag 320, a document set 325, and a metadata element 330 or structure defining element. Input from interface 320 can be used to create message 140 of system 100.

It should be appreciated that the interfaces shown in FIG. 2 and FIG. 3 are for illustrative purposes only and that the invention is not to be construed as limited to the precise arrangements and elements shown.

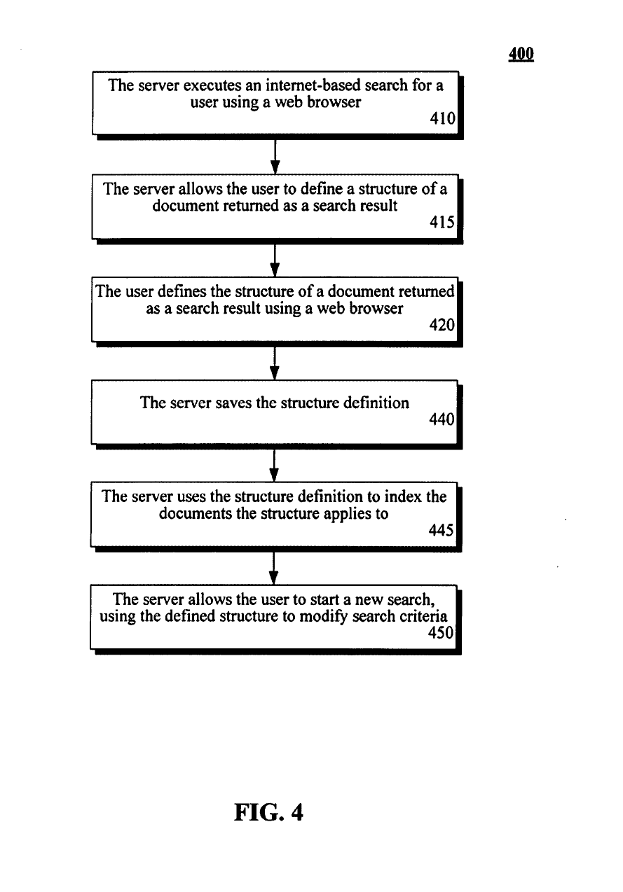

FIG. 4 is flow chart of a method 400 for using structure feedback in accordance with an embodiment of the inventive arrangements disclosed herein. Method 400 can be performed in the context of a system 100 or system 200.

Method 400 can begin in step 410, where the server executes an internet-based search for a user using a Web browser. In step 415, the server can allow the user to define a structure of a document returned as a search result. In step 420, the user can define the structure of a document returned as a search result using a Web interface in a Web browser. In step 440, the server can save the structure definition as defined by the user. In step 445, the server can use the structure definition to index the documents the structure applies to. The server can index the data elements defined specifically, to allow searching the structured documents by the defined data elements. In step 450, the server can allow the user to start a new search, using the defined structure to modify the search criteria.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A method of using user provided structure feedback to index electronic documents comprising:
a search engine serving search results based on an indexed store of electronic documents to at least one user;
receiving structure feedback concerning search results, said structure feedback identifying at least one structure element of an electronic document and at least one user specified semantic tag for the structure element; and
changing the indexed store to incorporate the structure feedback, wherein the changed index store is used when subsequently serving search results.

2. The method of claim 1, further comprising:
after the changing step, receiving search criteria from a user comprising a semantic tag and a user provided value for the semantic tag;
searching the changed indexed store for entries having a structure element matching the semantic tag and having a value within the structure element matching the user provided value; and
the search engine serving search results based on the matchings to at least one user.

3. The method of claim 2, wherein the electronic documents comprise Extensible Markup Language (XML) documents, wherein the structure element is an XML tag, and wherein the user provided value is a text value appearing within a section of an XML document defined within the bounds of the XML tag.

4. The method of claim 3, wherein indexed store represents an index of World Wide Web documents, and wherein the search engine is a Web search engine.

5. The method of claim 4, further comprising:
establishing an XPATH expression for the received structure feedback, using the XPATH expression during the changing step.

6. The method of claim 2, wherein the indexed store comprises an index of electronic documents located in a local data store, wherein the search engine is a desktop search engine configured to search for electronic documents in the local data store.

7. The method of claim 1, wherein the search engine is a Web search engine, wherein the indexed store is an index resulting from crawling a Web Wide Web to index documents found on the World Wide Web, wherein the changing step generates Web crawling software agents configured to detect the structure element within Web documents and to index the Web documents based at least in part upon the structure element.

8. The method of claim 7, wherein the received structure feedback further comprises a user input expression, said method further comprising:
when the user input expression is not an XPATH expression, converting the user input expression into an XPATH expression; and
each of the Web crawling software agents using the XPATH expression to detect the structure element in accordance with the XPATH expression.

9. The method of claim 1, wherein an original version of the indexed data store lacks a-priori information concerning said at least one structure element and concerning semantics specified for the structure element using the semantic tag, wherein after the changing step the indexed data store comprises semantic information linked to the structure element constructed from the received structure feedback, wherein an original version is a version of the indexed data store that exists before structure feedback is received and processed.

10. The method of claim 9, further comprising:
repeating the receiving and processing steps for a plurality of users over a significant time, wherein the method is trained by user feedback to include semantic information concerning structure of the electronic documents, where the semantic information is used to enhance search results generated by the search engine.

11. The method of claim 1, wherein said steps of claim 1 are steps performed automatically by at least one machine in accordance with at least one computer program having a plurality of code sections that are executable by the at least one machine, said at least one computer program being stored in a machine readable medium.

12. A system for searching electronic documents indexed with user provided structure feedback comprising:
an index data store configured to index a set of electronic documents so that the set is able to be searched using user provided key word input; and
a search engine configured to accept the user provided key word input, wherein said search engine is further configured to use the index data store to discover a set of electronic documents most closely matching the user provided key word input, and to present results of the set of discovered electronic documents, wherein the index data store comprises a plurality of structure based indexes, wherein said structure based indexes are created from user provided structure feedback.

13. The system of claim 12, further comprising:
a feedback handler configured to accept user provided structure feedback; and
an indexer configured to process the user provided structure feedback and to create new indexing artifacts based upon the user provided structure feedback, wherein the indexing artifacts are used to index the index data store to change structure based indexes of the index data store.

14. The system of claim 13, wherein the set of electronic documents comprise Web documents, wherein the search engine is a Web search engine, and wherein the user provided key word input is entered via a Web browser, wherein the user provided structure feedback is entered via the Web browser, said system further comprising:
a plurality of Web crawling software agents configured to detect the structure element within Web documents and to index the Web documents based at least in part upon the structure element wherein the Web crawling software agents crawl a World Wide Web, and wherein the user provided structure feedback comprises a user input expression, which is used create code in the Web crawling software agents that programmatically identities the structure element within the crawled Web documents.

15. The system of claim 13, wherein an original version of the indexed data store lacks a-priori information concerning semantic information for said structure based indexes, wherein an original version is a version of the indexed data store that exists before structure feedback is received and processed, wherein after the structure feedback is received and processed by the feedback handler and indexer, the indexed data store comprises semantic information linked to structural elements of the set of electronic documents constructed from the user provided structure feedback.

16. The system of claim 15, wherein the feedback handler and indexer and continuously receiving and processing user provided structure feedback, which results in the semantic structure based indexes of the index data store being constantly modified in accordance with user feedback.

17. The system of claim 12, wherein the user provided structure feedback comprises a user provided expression and a semantic tag, wherein said user provided expression is used to programmatically identify the structure element of the electronic documents, and wherein the semantic tag is a user provided tag that is to be indexed against the structure element, wherein the search engine is configured to accept a semantic tag and a tag value as key word input, to search the index data store for structure elements matching the semantic tag and having a value within the structure element matching the tag value, and to serve search results based on the matchings.

18. The system of claim 17, wherein the indexed store comprises an index of electronic documents located in a local data store, wherein the search engine is a desktop search engine configured to search for electronic documents in the local data store.

19. A search engine feedback interface comprising:
a structure feedback element of a search engine feedback interface configured to permit a user to provide structure feedback concerning electronic documents resulting from user searches conducted with a search engine, wherein user provided structure feedback relates to metadata of the electronic documents, wherein the user provided structure feedback comprises user specified semantic tags, wherein the search engine establishes indexes the electronic documents so that the metadata structures of the electronic documents are associated with the user specified semantic tags, wherein the established indexes based upon the user provided structure feedback is used by the search engine when generating search results to be delivered to users.

20. The interface of claim 19, further comprising:
semantic tag input element configured to accept textual input, which is identified as the user specified semantic tag; and
expression input element configured to accept input defining a structure specifying expression, said accepted input comprising at least one of a regular expression and an XPATH expression, wherein the structure specifying expression defines the metadata structure.
